(19) United States
(12) Patent Application Publication
(10) Pub. No.: US 2024/0302615 A1
(43) Pub. Date: Sep. 12, 2024

(54) RECONFIGURABLE OPTICAL FIBER LUMEN HAVING OPTICAL FIBERS ATTACHED TO LUMEN MEMBRANE

(71) Applicant: CORNING RESEARCH & DEVELOPMENT CORPORATION, Corning, NY (US)

(72) Inventor: Kenneth Darrell Temple, JR., Newton, NC (US)

(21) Appl. No.: 18/657,053

(22) Filed: May 7, 2024

Related U.S. Application Data
(63) Continuation of application No. PCT/US2022/048905, filed on Nov. 4, 2022.
(60) Provisional application No. 63/281,122, filed on Nov. 19, 2021.

(51) Int. Cl. G02B 6/44

(52) U.S. Cl. CPC G02B 6/4429; G02B 6/4479

(57) ABSTRACT

Embodiments of the disclosure relate to a lumen. The lumen includes a plurality of optical fibers and a membrane having an inner surface and an outer surface defining a maximum thickness therebetween. The maximum thickness is 50 microns or less. Each optical fiber of the plurality of optical fibers is partially attached to the inner surface of the membrane. Also disclosed are embodiments of a method of manufacturing a lumen that is reversibly configurable between a planar configuration and a non-planar configuration while maintaining a sequence of a plurality of optical fibers and embodiments of an optical fiber cable including a plurality of such lumens.

### PRIORITY APPLICATION

This application is a continuation of International Patent Application No. PCT/US2022/048905, filed Nov. 4, 2022, which claims the benefit of priority of U.S. Provisional Application No. 63/281,122, filed on Nov. 19, 2021, the content of which is relied upon and incorporated herein by reference in its entirety.

### BACKGROUND

The disclosure relates generally to an optical fiber subunit and, in particular, to an optical fiber lumen having optical fibers attached to an inner surface of the lumen.

Optical fiber cables having a large number of optical fibers are becoming increasingly desirable. As the number of optical fibers within a cable increases, it becomes more difficult to maintain the organization of the optical fibers within the cable. Optical fiber ribbons may be used to maintain organization of the optical fibers within the cable, but optical fiber ribbons generally require a significant amount of free space within the cable. The incorporation of such free space within a cable design typically requires a larger cable design. However, this runs counter to a further desire to provide a small cable form factor such that the cables can be routed through existing ducts. Accordingly, the two commercial desires of providing a high optical fiber density (i.e., large number of optical fibers within a small form factor) while maintaining optical fiber organization are difficult to reconcile.

### SUMMARY

According to an aspect, embodiments of the disclosure relate to a lumen. The lumen includes a plurality of optical fibers and a membrane having an inner surface and an outer surface defining a maximum thickness therebetween. The maximum thickness is 50 microns or less. Each optical fiber of the plurality of optical fibers is partially attached to the inner surface of the membrane.

According to another aspect, embodiments of the disclosure relate to a method of manufacturing a lumen that is reversibly configurable between a planar configuration and a non-planar configuration while maintaining a sequence of a plurality of optical fibers. In the method, a membrane is formed around the plurality of optical fibers, and the membrane is treated such that a portion of each outer surface of each optical fiber of the plurality of optical fibers attaches to an inner surface of the membrane. The membrane has a thickness between the inner surface and an outer surface of the membrane that is 50 microns or less.

According to a further aspect, embodiments of the disclosure relate to an optical fiber cable. The optical fiber cable includes a cable jacket having an exterior surface and an interior surface. The exterior surface defines an outermost surface of the optical fiber cable, and the interior surface defines a central cable bore. The optical fiber cable also includes a cable core disposed within the central cable bore. The cable core includes a plurality of lumens in which each lumen includes a plurality of optical fibers and a membrane having an inner surface and an outer surface defining a maximum thickness therebetween. The maximum thickness is 50 microns or less. Each optical fiber of the plurality of optical fibers is partially attached to the inner surface of the membrane.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments. In the drawings:

FIG. 1 depicts a lumen having a plurality of optical fibers attached to an inner surface of a membrane of the lumen, according to an exemplary embodiment;

FIGS. 2A-2C depict a sequence of collapsing a lumen from a planar configuration to a non-planar configuration, according to an exemplary embodiment;

FIG. 3 depicts an optical fiber having an attachment material applied to an outer surface of the optical fiber, according to an exemplary embodiment;

FIG. 4 depicts an optical fiber having an attachment material applied within a coating of the optical fiber, according to an exemplary embodiment;

FIG. 5 depicts a membrane of a lumen having an attachment material incorporated therein, according to an exemplary embodiment;

FIG. 6 depicts a processing line including a treatment device for activating the attachment material of a lumen, according to an exemplary embodiment; and

FIG. 7 depicts an optical fiber cable including a plurality of lumens, according to an exemplary embodiment.

### DETAILED DESCRIPTION

Referring generally to the figures, various embodiments of a lumen containing a plurality of optical fibers attached to an inner surface of a surrounding membrane are provided. As described herein, the lumen is reconfigurable between a planar configuration and a non-planar configuration while maintaining a desired sequence of the optical fibers within the lumen. In this way, the lumen offers the advantages of an optical fiber ribbon in terms of fiber organization for mass fusion splicing without requiring the substantial free space within a cable tube associated with optical fiber ribbons. Additionally, the lumen allows the optical fibers to act like loose fibers that can be bundled together at high fiber density. As will be described in greater detail below, the optical fibers can be attached to the lumen in a variety of ways, including melt bonding, heat sealing, adhesives, curable resins, and chemical bonding, among others. Each of these exemplary embodiments will be described in greater detail below, and these exemplary embodiments are provided by way of illustration, and not by way of limitation. These and other aspects and advantages will be discussed in relation to the embodiments provided herein.

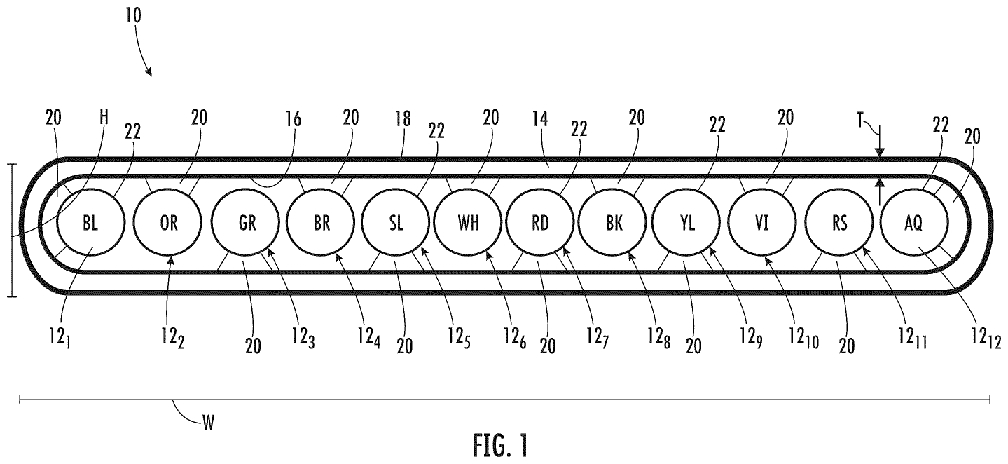

FIG. 1 depicts an embodiment of a lumen 10 including a plurality of optical fibers 12 contained within a membrane 14. In a first configuration shown in FIG. 1, the optical fibers 12 are arranged in a 1×12 substantially planar array within the membrane 14, similar to an optical fiber ribbon. In the first planar configuration, the lumen 10 comprises first dimensions, including a width W and a height H of the lumen 10. However, as will be discussed more fully below, the lumen 10 is able to assume a second, non-planar configuration having second dimensions that are different than the first cross-sectional area. In such a non-planar configuration, at least one of the width W or height H changes. For example, the maximum cross-sectional width W may decrease while the maximum cross-sectional height H increases. The lumen 10 can be reversibly transitioned between the first configuration (planar) and the second configuration (non-planar). For example, the lumen 10 may be manufactured and stored in the first configuration, transitioned to the second configuration when bundled into a cable core of an optical fiber cable, and then transitioned (over at least a portion of the length of the lumen 10) back to the first configuration for installation, e.g., for mass fusion splicing.

In this way, the lumen 10 operates like an optical fiber ribbon for organization and mass fusion splicing of the optical fibers 12. However, optical fiber ribbons typically require a large amount of free space within a cable tube because of the rigid planar configuration of the optical fiber ribbon. In contrast, the lumens 10 according to the present disclosure do not require large amounts of free space because the lumens 10 can be collapsed into the second configuration, allowing for the optical fibers 12 to act like loose optical fibers. This decreases the amount of free space necessary to accommodate the lumen 10 within a cable tube.

The lumen 10 is able to provide both the advantages of an optical fiber ribbon and loose optical fibers because the membrane 14 is flexible and the optical fibers 12 are attached to the membrane 12, which maintains their sequence when transitioning between the first configuration and the second configuration. The membrane 14 has an inner surface 16 and an outer surface 18. In one or more embodiments, the inner surface 16 and the outer surface 18 define a thickness T therebetween. In one or more embodiments, the maximum thickness T of the membrane 14 as measured at any location around the membrane 14 is 50 microns or less, 40 microns or less, or 30 microns or less. In one or more embodiments, the minimum thickness T of the membrane 14 as measured at any location around the membrane 14 is at least 10 microns thick. Further, in one or more embodiments, the membrane is made from a thermoplastic material, such as a polyester, a polypropylene, a polyamide, a polytetrafluoroethylene, or a polyethylene material. The combination of the thinness of the membrane 14 and the material from which it is made allow the lumen 10 to be flexible and reconfigurable.

As shown in FIG. 1, an attachment 20 joins each of the plurality of optical fibers 12 to the inner surface 16 of the membrane 14. The attachments 20 join the optical fibers 12 to the membrane 14 over only a portion of the exterior surface of each optical fiber 12. That is, each optical fiber 12 is substantially circular and has an outer circumferential surface 22, and only a portion of this outer circumferential surface 22 is attached to the inner surface 16 of the membrane 14. In one or more embodiments, the attachment 20 covers no more than 50% (i.e., an arc of 180°) of the outer circumferential surface 22 of each optical fiber 12 along at least a portion of the length of each optical fiber 12. In embodiments, the attachment 20 covers no more than 42%, no more than 34%, no more than 25%, or no more than 17% (i.e., arcs of 150° or less, 120° or less, 90° or less, 60° or less) of the outer circumferential surface 22. In embodiments, the attachment 20 covers at least 9% (i.e., an arc of 30° or more) of the outer circumferential surface 22.

However, as shown in FIG. 1, the location at which the attachment 20 joins the optical fiber 12 to the inner surface 16 of the membrane 14 varies based on individual optical fibers 12. According to an embodiment, the lumen 10 includes two edge fibers, the first optical fiber 12₁ and an nth optical fiber 12ₙ, that correspond to a beginning and end of a sequence of optical fibers 12. For example, a common color-coding sequence for twelve optical fibers 12 is blue (BL), orange (OR), green (GR), brown (BR), slate (SL), white (WH), red (RD), black (BK), yellow (YL), violet (VI), rose (RS), and aqua (AQ). The color-coding sequence helps to maintain the correct order of the optical fibers 12 so that signals are properly routed. If fewer than twelve optical fibers 12 are included in the lumen 10, then the sequence may terminate after the corresponding number of colors. Further, if more than twelve optical fibers 12 are included in the lumen 10, the sequence may repeat with the optical fibers 12 further including a stripe to differentiate between a previous blue, orange, green, etc. optical fiber 12. For the purpose of illustration, a lumen 10 with twelve optical fibers 12₁₋₁₂ having the color-coding sequence described herein is considered. In such embodiment, the first optical fiber 12₁ is the blue optical fiber, and the twelfth optical fiber 12₁₂ is the aqua optical fiber.

In one or more embodiments, when viewed from the planar configuration, the first optical fiber 12₁ is adjacent to only one other optical fiber 12₂, and the attachment 20 is located on the opposite side of the first optical fiber 12₁ from the adjacent optical fiber 12₂. Using analogy to a clock face, the attachment 20 of the first optical fiber 12₁ is substantially centered on the 9 o'clock position of the first optical fiber 12₁. The attachments 20 for the second optical fiber 12₂ through eleventh optical fiber 12₁₁ are located at an angular position rotated about 60° to about 120° (in particular about 90°) or about −60° to about −120° (in particular about −90°) from the angular position of the first fiber 12₁. Thus, the attachments 20 for the second optical fiber 12₂ through the eleventh optical fiber 12₁₁ are substantially centered at the 12 o'clock or 6 o'clock positions. The attachment 20 for the twelfth optical fiber 12₁₂, like the first optical fiber 12₁, is positioned on the side of the twelfth optical fiber 12₁₂ opposite to adjacent optical fiber 12₁₁. Thus, the attachment 20 of the twelfth optical fiber 12₁₂ is substantially centered on the 3 o'clock position of the twelfth optical fiber 12₁₂, which is an angular position rotated about 150° to about 210° (in particular about 180°) From the first optical fiber 12₁.

In one or more embodiments, the attachments 20 for intermediate optical fibers, i.e., the second optical fiber 12₂ through the eleventh optical fiber 12₁₁, may alternate each optical fiber such that the attachments 20 for the second optical fiber 12₂, fourth optical fiber 12₄, sixth optical fiber 12₆, eighth optical fiber 12₈, and tenth optical fiber 12₁₀ are at the same first angular position. In such an embodiment, the attachments 20 for the third optical fiber 12₃, fifth optical fiber 12₅, seventh optical fiber 12₇, ninth optical fiber 12₉, and eleventh optical fiber 12₁₁ are at the same second angular position that is about 180° from the first angular position.

In one or more embodiments, attachments 20 for each optical fiber 12 of groups of consecutive optical fibers 12 may have the same angular position. For example, the optical fibers 12 may be arranged in groups of two, three, four, or six. In this way, the attachments 20 for all the optical fibers 12 in each group will have the same angular position (except for the first optical fiber 12₁ and the twelfth optical fiber 12₁₂ at the edges).

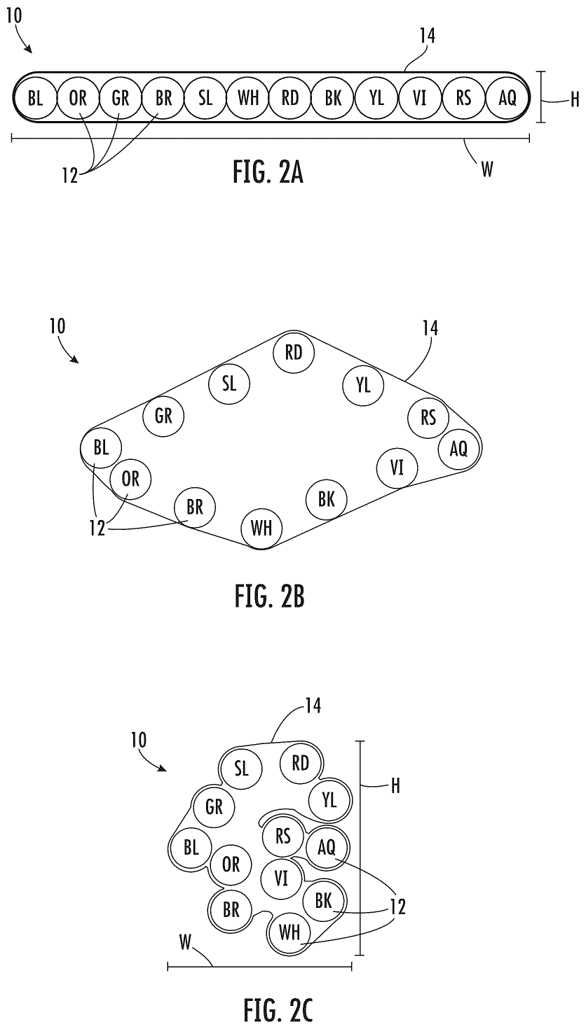

A lumen 10 having optical fibers 12 attached to the membrane in this way can be collapsed as shown in the simplified sequence shown in FIGS. 2A-2C. The first, planar configuration is depicted in FIG. 2A. FIG. 2B depicts an initial collapsing of the lumen 10 during which the first optical fiber 12₁ and the twelfth optical fiber 12₁₂ are pushed together. The odd numbered optical fibers 12 separate from the even numbered optical fibers 12. As the lumen 10 is further collapsed, the optical fibers 12 continue to squeeze together in a tight bundle to assume the second, non-planar configuration as shown in FIG. 2C. As can be seen in a comparison of FIGS. 2A and 2C, the maximum cross-sectional height H and width W of the lumen 10 change, allowing the lumen 10 to pack more densely within the central bore of an optical fiber cable.

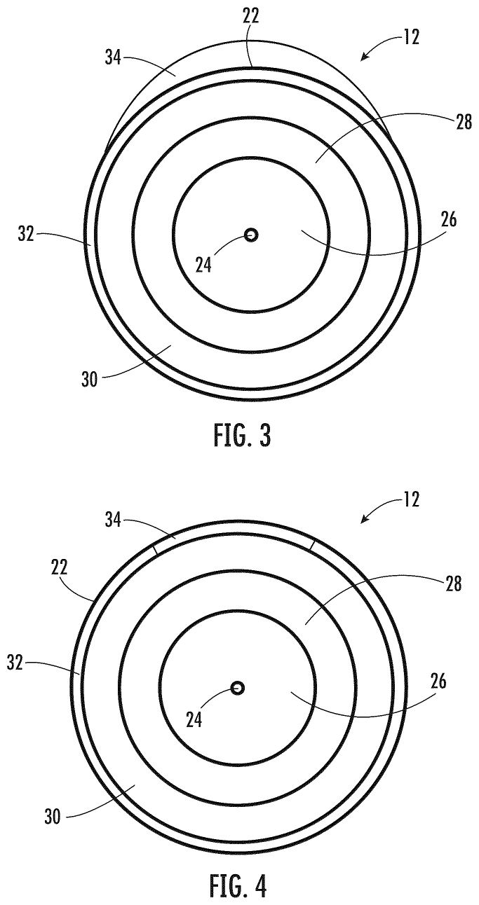

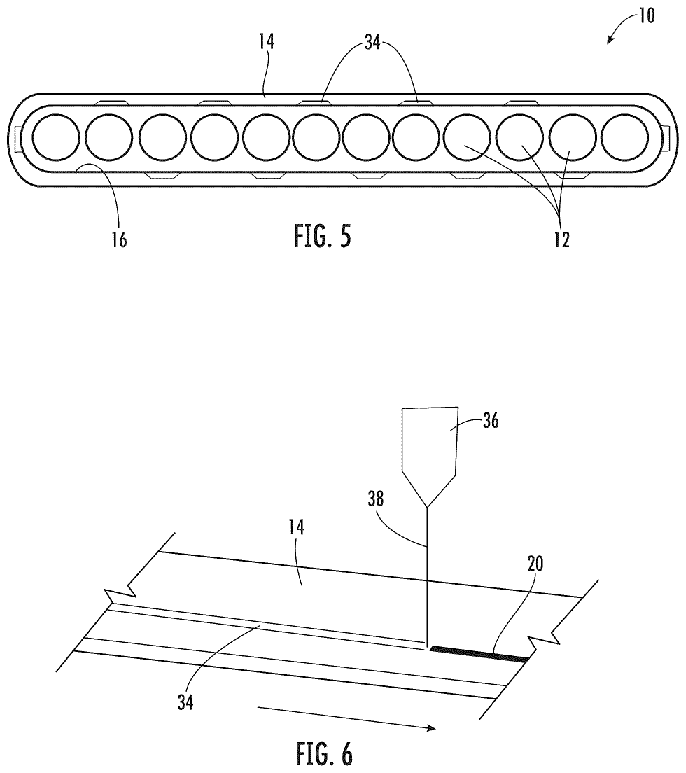

The attachments 20 joining the optical fibers 12 to the inner surface 16 of the membrane 10 can be formed in a variety of ways, examples of which are provided hereinbelow. According to a set of embodiments, the attachments 20 comprise a material added between the optical fibers 12 and the inner surface 16 of the membrane 14 as will described below in relation to FIG. 3. According to another set of embodiments, the attachments 20 are created using a material included as part of a coating of the optical fibers 12 as will be described below in relation to FIG. 4. According to still another set of embodiments, the attachments 20 are created using a material included in the membrane 14 or on the inner surface 16 of the membrane 14 as will be described below in relation to FIG. 5. In still other embodiments, the attachments 20 may be created by a combination of any of the foregoing embodiments, such as a material included in or on the membrane 14 interacting with a material coated on or included in a coating of the optical fiber 12.

Referring first to FIG. 3, a cross-sectional view of an optical fiber 12 is depicted. In one or more embodiments, the optical fibers 12 each include a core 24 surrounded by a cladding 26. In embodiments, the cladding 26 is surrounded by one or more coating layers, such as primary coating 28, secondary coating 30, and ink coating 32. In one or more embodiments, the ink coating 32 (if provided) defines the outer circumferential surface 22 of the optical fiber 12 in which case the optical fiber 12 is a colored optical fiber 12. The coloring of the ink coating 32 may provide the above-described color-coding sequence of the optical fibers 12. In one or more other embodiments, the secondary coating 30 defines the outer circumferential surface 22 of the optical fiber 12 in which case the optical fiber 12 is considered a bare optical fiber 12. In one or more embodiments, the core 24 and cladding 26 are glass materials, and the primary coating 28, secondary coating 30, and ink coating 32 are curable resin materials.

As shown in FIG. 3, an attachment material 34 is applied over the outer surface 22 of the optical fibers 12. In such embodiments, a continuous or discontinuous strip of attachment material 34 may be applied to optical fibers 12 before the membrane 14 is extruded or otherwise formed around the optical fibers 12. In one or more embodiments, the attachment material 34 is an adhesive, such as a pressure sensitive adhesive, a hot melt adhesive, or an induction cure adhesive, among other possibilities.

In one or more other embodiments, the attachment material 34 is a strip of cure-inhibited resin. In such embodiments, a curable resin may be applied to the outer surface 22 of the optical fiber 12, and the strip of curable resin is cured, e.g., using UV light, heat, and/or moisture, in a cure-inhibiting atmosphere (e.g., an oxygen atmosphere), which inhibits curing of an outer nano-layer of the curable resin. When the membrane 14 is extruded or otherwise formed around the optical fibers 12, the cure-inhibited resin can undergo another curing step which will cause the outer nano-layer of the uncured or partially cured curable resin to bond to the inner surface 16 of the membrane 14. In one or more embodiments, the further curing step may be a thermal step in which the heat from the molten, extruded membrane 14 activates the uncured resin. In one or more other embodiments, the further curing step may be a UV curing step in which the membrane 14 is thin (e.g., 20 microns or less) and UV-transparent to allow UV light to pass through the membrane 14 to cure the curable resin.

In the embodiment shown in FIG. 4, the attachment material 34 is included in the outermost coating of the optical fiber 12. In the embodiment depicted, the outermost coating is the ink coating 32. During application of the ink coating 32, a strip of attachment material 34 is applied within the ink coating 32 material. In one or more embodiments, the attachment material 34 comprises an adhesive, such as a pressure sensitive adhesive, a hot melt adhesive, or an induction cure adhesive, among other possibilities.

In another embodiment, the strip of attachment material 34 may be a strip of cure-inhibited resin. In particular, the ink coating 32 may be a curable resin, and the attachment material 34 may be a strip of cure-inhibited resin disposed within the ink coating 32. In such embodiments, the strip can be produced by inhibiting a portion of the ink coating 32 from curing, e.g., using oxygen inhibition. For example, a stream of oxygen can be jetted onto the ink coating 32 during curing to prevent a strip of the ink coating 32 having a depth of a few nanometers from fully curing. After the membrane 14 is extruded or otherwise formed around the optical fibers 12, the cure-inhibited region of material 34 can be cured (e.g., thermally or using UV light as described above) to bond with the inner surface 16 of the membrane 14.

In FIG. 5, the membrane 14 includes strips of attachment material 34 for forming the attachments between the membrane 14 and the optical fibers 12. As can be seen, the strips of attachment material 34 are located over where it is desired to join the optical fiber 12 to the inner surface 16 of the membrane 14. The strips of attachment material 34 can be formed by co-extruding the attachment material 34 on the inside surface 16 the material of the membrane 14. In embodiments, the attachment material 34 may be an adhesive material, such as a pressure sensitive adhesive, a hot melt adhesive, an induction cure adhesive, or a cure-inhibited resin, among others. Alternatively, in embodiments, the attachment material 34 may be the material of the membrane 14. For example, the membrane 14 may be extruded or treated in such a manner that the material of the membrane 14 forms a melt bond with the outer surface 22 of the optical fiber 12.

FIG. 6 depicts a method of forming the attachments between the optical fibers 12 and the membrane 14. As shown in FIG. 6, the lumen 10 may be moving past a treatment device 36 configured to activate the attachment material 34 of the membrane 14 or the optical fiber 12 or both. In the embodiment shown in FIG. 6, the treatment device 36 is a laser directing a beam 38 onto the membrane 14. In one or more embodiments, the beam 38 may provide the requisite heat energy, e.g., to activate a hot melt adhesive or to form a melt bond using the material of the membrane. In one or more other embodiments, the beam 38 may be of a particular wavelength, such as UV wavelength, to cause curing of uncured materials to create an attachment between the optical fiber 12 and the inner surface of the membrane 14. In one or more other embodiments, the treatment device 36 may create electromagnetic fields that activate an induction cure material. Such materials may contain metal particles that respond to an alternating electric field to produce heat. The heat is highly localized in the location of the induction cure material, allowing for the creation of localized bonding without substantially affecting the surrounding area. In one or more other embodiments, the treatment device 36 may be a set of rollers configured to activate a pressure sensitive adhesive material to attach the optical fibers 12 to the membrane 14.

FIG. 6 depicts a continuous process for treating the attachment material 34. As the lumen 10 moves past the treatment device 36, the attachment material 34 becomes an attachment 20 between the membrane 14 and the optical fiber 12. Further, while a single treatment device 36 is depicted, the processing line may contain two or more treatment devices 36 arranged across the width of the lumen 10 or staggered across the width of the lumen 10. Additionally, a continuous strip of attachment material 34 is shown, but in one or more other embodiments, the attachment material 34 may be in a discontinuous strip such that the optical fibers 12 are intermittently attached to the membrane 14 along the length of the lumen 10. Advantageously, the process is not limited in terms of length of lumen 10 that can be treated. Applicant believes that the process would be capable of essentially endless or continuous treatment of lumens 10, e.g., only limited by length of the optical fibers 12 and/or payoff or takeup reel package sizes.

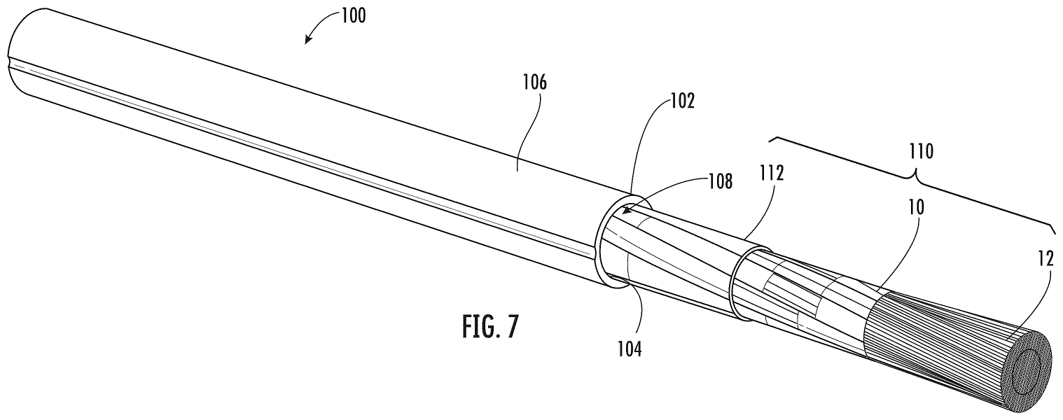

The lumens 10 as described herein can be incorporated into an optical fiber cable 100 as shown in FIG. 7. The optical fiber cable 100 includes a cable jacket 102 having an interior surface 104 and an exterior surface 106. The exterior surface 106 defines an outermost surface of the optical fiber cable 100, and the interior surface 104 defines a central cable bore 108. A cable core 110 including a plurality of lumens 10 as described above are disposed within the central cable bore 108. As can be seen in FIG. 7, the lumens 10 are bundled within the cable core 110 such that there is a high density of optical fibers 12 within the optical fiber cable 100. In embodiments, the optical fiber cable 100 may include from 48 to 864 optical fibers 12 arranged in four to seventy-two lumens 10.

In one or more embodiments, the lumens 10 may be stranded (helically or SZ-stranded) in the cable core 110. Further, in one or more embodiments, the cable core 110 may include a binder 112 wrapped or extruded around the lumens 10, and such binder 32 may help maintain the stranding of the lumens 10 and/or provide water-blocking functionality.

In one or more embodiments, the cable core 110 does not include a strength member, such as a glass-reinforced rod, metal wire, or tensile strands (e.g., aramid or glass yarns). In one or more embodiments, the optical fiber cable 100 does not include a strength member. Instead of such strength members, the optical fiber cable 100 according to embodiments of the present disclosure uses the optical fibers 12 as the strength member for the optical fiber cable 100. In particular, the grouping of the optical fibers 12 into lumens 10 allows the optical fibers 12 to act as a composite strength member by reducing the amount of free space within the optical fiber cable 100 and within the lumen 10. In one or more embodiments, the optical fiber cable 100 comprises a free space of 40% or less, 30% or less, 25% or less, or even as low as 20%. In such embodiments, the free space may be defined as the inverse of the area of the central cable bore 108 as defined by the interior surface 104 of the cable jacket 102 less the cumulative area of the optical fibers 12 within the cable bore 108. The cumulative area of optical fibers 12 is the sum of the area of each optical fiber 12. Thus, if the optical fibers 12 occupy 75% of the area of the central cable bore 108, then the free space would be 25%.

As described herein, an optical fiber cable 100 including the lumens 10 according to the presently disclosed embodiments provides both high fiber density and maintains organization of the optical fibers 12 within a fiber group.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A lumen, comprising:
a plurality of optical fibers;
a membrane having an inner surface and an outer surface defining a maximum thickness therebetween, the maximum thickness being 50 microns or less;
wherein each optical fiber of the plurality of optical fibers is partially attached to the inner surface of the membrane.

2. The lumen of claim 1, wherein the lumen is reconfigurable between a first configuration in which the plurality of optical fibers are arranged in a planar array and a second configuration in which the plurality of optical fibers are not planarly arranged.

3. The lumen of claim 2, wherein the optical fibers are arranged in a sequence in the first configuration and wherein, when reconfiguring from the second configuration to the first configuration, the sequence of the optical fibers is maintained.

4. The lumen of claim 1, wherein an adhesive is disposed between each optical fiber of the plurality of optical fibers and the inner surface of the membrane.

5. The lumen of claim 4, wherein the adhesive comprises at least one of a pressure sensitive adhesive, a hot melt adhesive, an induction curable adhesive, or a cure-inhibited resin.

6. The lumen of claim 1, wherein each optical fiber of the plurality of optical fibers is attached to the inner surface of the membrane by a melt bond formed by a material of the membrane.

7. The lumen of claim 1, wherein the membrane comprises a plurality of strips of attachment material that attach the optical fibers to the inner surface of the membrane.

8. The lumen of claim 1, wherein, at each location along a length of each optical fiber, no more than 50% of an outer circumferential surface of each optical fiber is attached to the inner surface of the membrane.

9. The lumen of claim 1, wherein, as viewed in a planar configuration, a first attachment of a first optical fiber of the plurality of optical fibers is formed at a first angular position of the first optical fiber, a second attachment of a last optical fiber of the plurality of optical fibers is formed at a second angular position of the last optical fiber that is oriented about 150° to about 210° from the first angular position of the first optical fiber, and intermediate attachments of intermediate optical fibers of the plurality of optical fibers are formed at third angular positions of each intermediate optical fiber oriented about 60° to about 120° or about −60° to about −120° from the first angular position and from the second angular position.

10. A method of manufacturing a lumen that is reversibly configurable between a planar configuration and a non-planar configuration while maintaining a sequence of a plurality of optical fibers, comprising:
forming a membrane around the plurality of optical fibers;
treating the membrane such that a portion of each outer surface of each optical fiber of the plurality of optical fibers attaches to an inner surface of the membrane;
wherein the membrane comprises a thickness between the inner surface and an outer surface of the membrane, the thickness being 50 microns or less.

11. The method of claim 10, further comprising:
applying a strip of an attachment material to each optical fiber of the plurality of optical fibers before forming the membrane around the plurality of optical fibers.

12. The method of claim 11, wherein the attachment material comprises an adhesive selected from the group consisting of pressure sensitive adhesive, hot melt adhesive, induction curable adhesive, and cure-inhibited resin.

13. The method of claim 10, further comprising:
forming a strip of attachment material within an outer coating layer of each optical fiber of the plurality of optical fibers prior to forming the membrane around the plurality of optical fibers.

14. The method of claim 13, wherein the outer coating layer is an ink coating of the optical fiber.

15. The method of claim 10, wherein forming the membrane further comprises co-extruding a membrane material with an attachment material to form strips of attachment material within the membrane.

16. The method of claim 10, wherein treating comprises applying laser radiation to the membrane to cause the membrane to melt and form a melt bond with each optical fiber.

17. The method of claim 10, wherein treating comprises creating an alternating electromagnetic field to cause inductive heating of metal particles included in an attachment material that is at least one of (i) disposed in the membrane, (ii) disposed in an outer coating of each optical fiber, or (iii) disposed between the membrane and each optical fiber;
wherein the inductive heating melts the attachment material to attach the portion of each outer surface of each optical fiber to the inner surface of the membrane.

18. The method of claim 10, wherein treating comprises applying pressure to the membrane to activate a pressure sensitive adhesive that is at least one of (i) disposed in the membrane, (ii) disposed in an outer coating of each optical fiber, or (iii) disposed between the membrane and each optical fiber.

19. The method of claim 10, wherein treating comprises exposing the membrane to UV light to cure a strip of cure-inhibited resin disposed in an outer coating of each optical fiber of the plurality of optical fibers or disposed between each optical fiber of the plurality of optical fibers and the inner surface of the membrane.

20. An optical fiber cable, comprising:
a cable jacket having an exterior surface and an interior surface, the exterior surface defining an outermost surface of the optical fiber cable and the interior surface defining a central cable bore;
a cable core disposed within the central cable bore;
wherein the cable core comprises a plurality of lumens, each lumen comprising:
a plurality of optical fibers;
a membrane having an inner surface and an outer surface defining a maximum thickness therebetween, the maximum thickness being 50 microns or less;
wherein each optical fiber of the plurality of optical fibers is partially attached to the inner surface of the membrane.
